(19) United States
(12) Patent Application Publication
(10) Pub. No.: US 2010/0266747 A1
(43) Pub. Date: Oct. 21, 2010

(54) COMBINED CRYSTAL/OPTICAL ASSEMBLY AND METHOD OF ITS USE

(75) Inventor: William B. Strickland, Lake Oswego, OR (US)

Correspondence Address: KOLISCH HARTWELL, P.C., 200 PACIFIC BUILDING, 520 SW YAMHILL STREET, PORTLAND, OR, 97204, US

(73) Assignee: FLIR SYSTEMS, INC., Wilsonville, OR (US)

(21) Appl. No.: 12/427,653

(22) Filed: Apr. 21, 2009

(51) Int. Cl. B05D 7/00; B05C 11/00

(52) U.S. Cl. 427/8; 118/712

(57) ABSTRACT

Systems, including apparatus and methods, for monitoring and controlling fabrication of thin-film coatings on a target substrate, thereby providing coatings with highly accurate thicknesses and indices of refraction.

### INTRODUCTION

A coating system for optical components generally is housed in a vacuum or partial vacuum chamber within which a number of elements reside. The elements may include: a source of material to be deposited as a coating; an energy source for vaporizing the source material; a support such as a planetary support for simultaneously moving and supporting objects to be coated; and a monitoring system for monitoring the thickness or other characteristic of a material deposited as a coating. Generally, the planetary support moves within the vacuum chamber, with some or all of the other elements being fixed at least during the coating process.

In a typical coating system, target objects to be coated are moved within the vacuum chamber as the coating material is vaporized. Using the planetary system, objects move around both their own axis of rotation and the axis of rotation of the support; moving through the space of the vacuum chamber in this manner corrects for any spatial variations in the vapor of the deposition material and allows even coating of the target objects. A monitor within the vacuum chamber is coated at roughly the same rate as the target objects and a signal from the monitor reflects the extent to which it is coated. This monitor signal is then used to control the rate and/or extent of coating that occurs for both the monitor and the target objects. Typically, the monitor extends vertically or horizontally from a wall of the vacuum chamber toward its middle.

Having accurate information regarding the thickness of a material deposited on a coated object can be an important factor in the later use of that object for its intended purpose. For example, precise control of the characteristics of an optical coating on an optical component, such as a camera lens, may be an important factor in determining the operational characteristics of that component. Transmission through and reflection from an optical component can be affected by a number of parameters, including the identity and nature of a transparent coating material provided on that component and the construction of the component itself.

Typically, light interacts with a thin-film coating by an interference effect whereby light rays reflected from the coating interfere with rays that pass through the coating and reflect from an underlying surface. In a coating having multiple types of layers, each with a thickness and a refractive index, a portion of the incident light may reflect from the interface between each successive layer, resulting in a complicated interference effect that determines the characteristics of both the light that is ultimately reflected from the coated component and the light that is transmitted through it. The different interactions between the layers of a coating and an incident light wave can be exploited by using a defined coating “recipe” to manufacture an optical component having distinct operational characteristics in a given spectrum of light.

Many techniques exist for monitoring the characteristics of an optical film deposited on an optical component. Two common techniques are optical monitoring and quartz crystal monitoring.

Optical monitoring generally involves detecting and responding to changes in the interaction of light with an optical coating on an optical monitor component. An optical monitoring system usually includes a light projector to send a light beam, an optical component to reflect the light beam (and to which a coating layer is applied), and a light receiver or detector to receive and detect the reflected light. A user of the system can track the deposition of an optical coating onto the optical component by following changes in the reflectance of the light beam sent by the projector and received at the detector. Deposition of the coating onto the optical component ideally should be comparable to deposition of the coating onto a target object in the same vacuum chamber, and the user will have pre-determined the change in the characteristics of the reflected light that corresponds to a desired optical layer thickness. Thus, to make a single-layer coating on a target object, the user can follow the deposition of that coating onto an optical component using the monitor. To make a multi-layer coating on a target object, the user can follow the deposition of the layers sequentially, applying and monitoring deposition of one layer at a time to an optical component used for monitoring until the desired multi-layer coating is finished. To accomplish accurate monitoring of each layer's deposition, the user can discard each optical component used as a monitor after it is used to monitor a given layer, providing a new optical component for monitoring at each layering step.

Quartz crystal monitoring involves detecting and responding to changes in the resonance frequency of a quartz crystal as an optical coating or other material is deposited on the crystal. An electrically energized quartz crystal resonates at a given frequency. The resonance frequency of the crystal depends substantially upon the mass and geometry of the crystal, and thus a change in mass of the crystal will result in a change in its resonance frequency. A user of a coating system can calculate, in advance, the amount (mass) of material that must be deposited onto the crystal to cause a given change in the crystal's resonance frequency. The user can then monitor and measure the deposition of a material layer by watching for the predetermined change in the resonance frequency of the crystal.

In a simple construct, a quartz thickness monitor may include two crystals, one experimental crystal and one reference crystal. A monitor of this type is used in the SPI-MODULE™ quartz crystal thickness monitor sold by Structure Probe, Inc. of West Chester, Pa. Typically, the experimental crystal resides in a vacuum chamber with the target objects to be coated with a material layer, whereas the reference crystal resides outside the vacuum chamber, or at least in a location where it is not coated by a material layer. At the beginning of a coating process, the difference between the resonance frequencies of the two crystals (if there is one) can be set to zero. During material deposition, the mass of the experimental crystal will rise and, thus, its resonance frequency will drop. At the same time, changes in resonance frequency of the reference crystal may be monitored and used to correct for changes in resonance frequency of the experimental crystal that are not due to material deposition, such as changes due to ambient conditions. This allows a more accurate determination of the actual addition in mass to the experimental crystal. Given the measured change in mass on the experimental crystal, and a known density of the material, the thickness of a material layer deposited on the crystal (and the target objects) can be derived. Accordingly, the rate of mass deposition can be decreased as a desired thickness is approached, and deposition can be stopped when the desired thickness is achieved. Other methods of monitoring material deposition on a reference component, such as that disclosed in U.S. Pat. No. 5,112,642 to Wajid (Measuring and Controlling Deposition on a Piezoelectric Monitor Crystal) could also be used.

Although quartz is discussed as a typical crystal used in monitoring and controlling a material deposition process, it should be appreciated that any appropriate piezoelectric crystal can be used. For example, ceramic resonators like barium titanate, lead zirconium titanate, and zirconium-toughened alumina, among others, may also be used for crystal monitoring. Desirable features in a crystal monitor material include a precise resonance frequency that can be readily monitored, and a low temperature dependence of the crystal's resonance frequency so that temperature variations occurring during the coating process will have a relatively small effect on the resonance frequency compared to the effect of mass changes resulting from material deposition.

### SUMMARY

The present teachings provide systems, including apparatus and methods, for monitoring and controlling fabrication of thin-film coatings on a target substrate, thereby providing coatings with highly accurate thicknesses and optical characteristics.

### BRIEF DESCRIPTION OF THE DRAWINGS

FIG. 1 is a schematic view of an exemplary monitoring and controlling system including a crystal holder assembly and an optical component assembly, in accordance with aspects of the present teachings.

FIG. 2 is a top plan view of a crystal holder assembly, in accordance with aspects of the present teachings.

FIG. 3 is a bottom plan view of the crystal holder assembly of FIG. 2.

FIG. 4 is a perspective view of the crystal holder assembly of FIG. 2.

FIG. 5 is a perspective view of a crystal holder, in accordance with aspects of the present teachings.

FIG. 6 is a bottom plan view of the crystal holder of FIG. 5.

FIG. 7 is a top plan view of the crystal holder of FIG. 5.

FIG. 8 is a perspective view of a base plate, in accordance with aspects of the present teachings.

FIG. 9 is a bottom plan view of the base plate of FIG. 8.

FIG. 10 is a cross-sectional view of the base plate of FIG. 9, taken along line 10-10 of FIG. 9.

FIG. 11 is a perspective view of a Geneva gear support, in accordance with aspects of the present teachings.

FIG. 12 is a perspective view of a Geneva gear, in accordance with aspects of the present teachings.

FIG. 13 is a perspective view of a Geneva gear driver, in accordance with aspects of the present teachings.

FIG. 14 is a front view of the exemplary monitoring and controlling system of FIG. 1 including shielding that may be used with the assembly.

### DETAILED DESCRIPTION

The present teachings provide systems, including apparatus and methods, for monitoring and controlling fabrication of thin-film coatings on a target substrate, thereby providing coatings with highly accurate thicknesses and optical characteristics. The systems may include a crystal holder assembly configured to monitor a first material deposition event and an optical component holder configured to monitor a second material deposition event, where the crystal holder and the optical component holder are arranged about a shared axis of rotational symmetry. The crystal holder assembly might be constructed of several components, including a crystal holder and a base plate, with both the crystal holder and the base plate having rotational symmetry. The described systems provide for accurate and repeatable deposition of optical coatings on optical components at relatively low cost and with a relatively high degree of performance.

In an illustrated embodiment, the crystal holder and the base plate are arranged coaxially, such that central openings in each of the holder and the base plate are aligned. The crystal holder assembly might include a plurality of crystal sites, each configured to support at least one quartz crystal. With the central openings of the holder and base plate being aligned, an optical component holder may be arranged in the center of the crystal holder assembly, resulting in a central optical monitor being surrounded by a plurality of quartz crystal monitors. This combined crystal/optical monitoring system can provide real time, highly accurate information regarding coating deposition rates and measurements of optical coating thickness.

In one embodiment, the crystal holder has eight-fold rotational symmetry, and the base plate is substantially circular. Furthermore, the crystal holder and base plate may be arranged in a stacked orientation, with the crystal holder residing above the base plate. In such an arrangement, the base plate may include exposure openings that allow exposure of at least a portion of the crystal holder to an atmosphere in a vacuum chamber used for a material deposition process. Optimally, the openings in the base plate allow exposure of a crystal held in the crystal holder to a source of material deposited on a target object in the vacuum chamber.

In some embodiments, each crystal might be held reversibly in a crystal drawer, with the drawer being configured for easy placement in and removal from the crystal holder. This design may allow for replacement of crystals in the monitor with no disassembly of the monitoring and controlling system, resulting in consistency of tooling factors (the ratio between the film thicknesses on the target object and the crystal or optical monitor) over a number of runs.

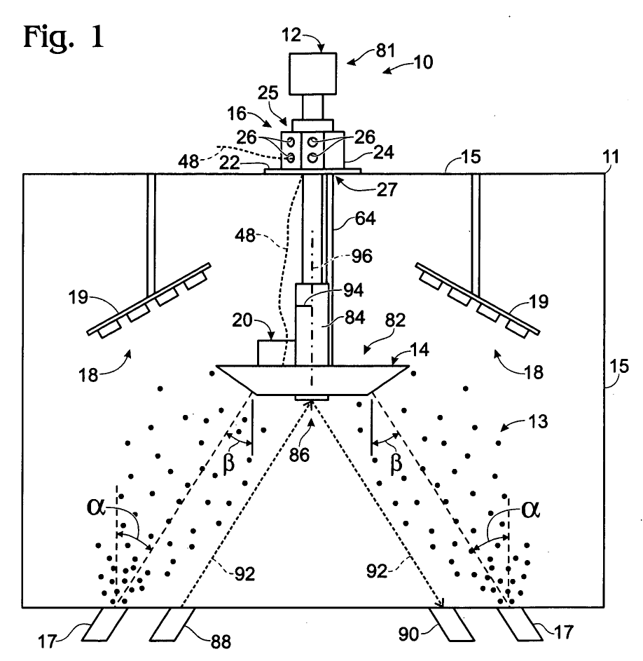

FIG. 1 shows an exemplary monitoring and controlling system 10 for use with a vacuum chamber 11 in which a material deposition process occurs. Monitoring and controlling system 10 may also be described as a combined crystal/optical assembly. System 10 may include an optical component assembly 12 and a crystal holder assembly 14. System 10 may be supported at a wall 15 of the vacuum chamber by a chamber pass-through 16. In use, the monitoring and controlling assembly 10 may monitor and control the deposition of materials 13, produced by emitters 17, on target objects 18. Target objects 18 may reside, during the deposition process, on planetary supports 19. An included Geneva gear assembly 20 may facilitate movement of at least a portion of crystal holder assembly 14 (as described in more detail below).

Because the monitoring and controlling assembly 10 may span a wall 15 of a vacuum chamber 11, it may be important to maintain the integrity of a vacuum induced within the chamber while still allowing control of elements of the assembly 10 within the chamber. Pass-through 16 may thus include a flange 22 coupled to the vacuum chamber wall and to a pass-through body 24, to avoid any undesirable leaking of atmospheric gases into chamber 11. In the illustrated embodiment, a single pass-through body 24 may accommodate an optical component assembly opening 25, one or more communication openings 26, and one or more cooling apparatus openings 27.

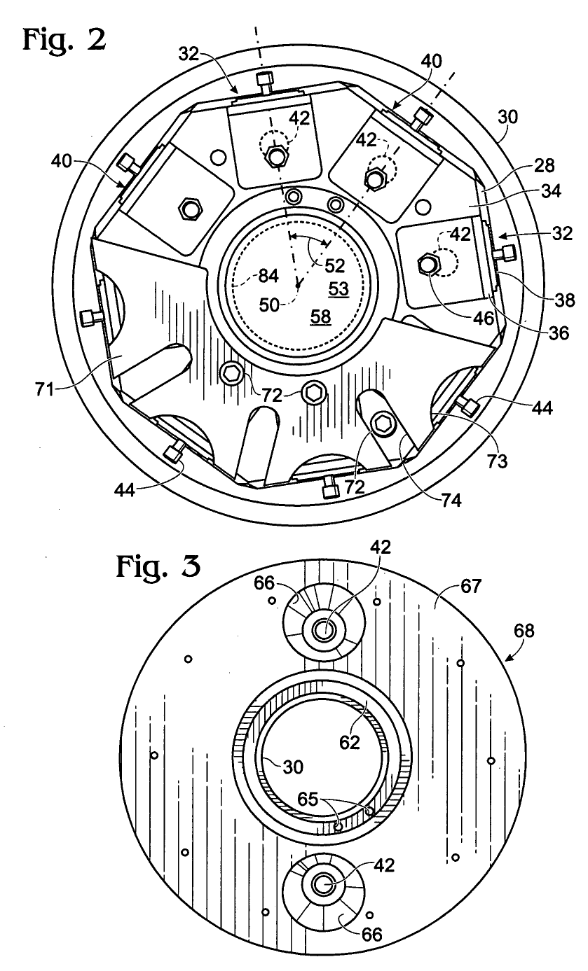

FIGS. 2-4 show that crystal holder assembly 14 may include multiple components, such as a crystal holder 28 and a base plate 30. As shown in the figures, the base plate and crystal holder may be “layered,” or configured so that the crystal holder 28 resides above the base plate 30 when the assembly is in its operative state. Because emitters 17 and other elements used in the coating operation are generally placed at the bottom of a vacuum chamber, having the base plate in a position below the crystal holder allows the base plate to protect crystals in the holder from heat and materials produced at the bottom of the chamber, except as desired. Excessive heating could, for example, influence the resonance frequency of crystals held in the crystal holder, causing a frequency shift in those crystals to be an inaccurate reflection of the amount of material deposited on them.

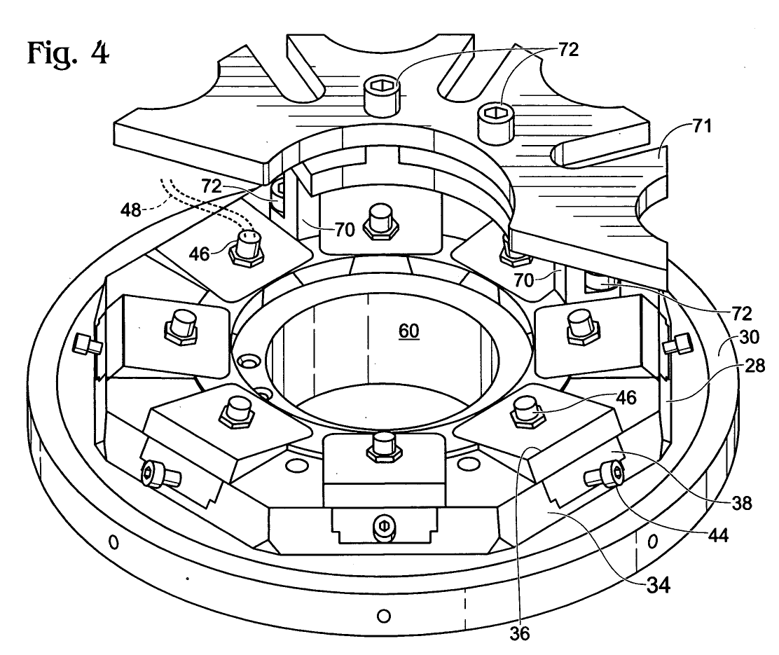

FIGS. 2, 4 and 5-7 show an exemplary embodiment of a crystal holder 28 according to the present disclosure. As seen in FIGS. 2 and 4, the crystal holder may include a number of crystal sites 32 defined by a holder body 34 and a site roof 36. A crystal drawer 38 may be removably placed into a drawer slot 40 at the crystal site. The crystal drawer 38 may be a holder for a crystal 42 (see FIG. 2) used in the process of monitoring material deposition. An exemplary crystal drawer is the COOL WAVE™ drawer manufactured by the Maxtek, Inc. of Santa Fe Springs, Calif., now owned by Inficon, Inc. For ease of placement and removal, crystal drawer 38 may be fitted with a drawer pull 44. A user may replace a given crystal by grasping a drawer pull 44 on a drawer 38 and sliding the drawer out of and into the crystal drawer slot 40.

So that the resonance frequency of a crystal residing in each crystal drawer can be monitored, a crystal wire connection 46 (see FIG. 4) may be provided for each crystal site. Typically, the crystal wire connection 46 will be electrically coupled to the crystal 42 through contacts in the crystal drawer 38. A control wire 48 may extend from each connection 46 toward pass-through 16, at which point the control wire may exit the vacuum chamber and connect to control circuitry via communication openings 26. This design, where each crystal site has its own wire connection, allows the resonance frequency of each crystal in the crystal holder to be read at the same time, regardless of whether the crystal is actively monitoring material deposition or is simply being readied for movement into a monitoring position. However, it should be appreciated that other configurations wherein two or more crystals are simultaneously monitored through a single connection are within the scope of the present teachings.

Crystal sites 32 may be arranged about the crystal holder 28 with radial symmetry. For example, in the illustrated embodiment, eight crystal sites are arranged around a central axis 50 of the holder, with each site separated from its neighbor sites by an angle 52 of about forty-five degrees, as may be seen in FIG. 2. In other embodiments according to the present teachings, there may be more or fewer crystal sites, and they be spaced equally about the central axis, or they may be grouped, according to operational considerations. For example, there may be four equally-spaced site separated by angles of ninety degrees, or there may be two widely-spaced groups having four closely-spaced sites each.

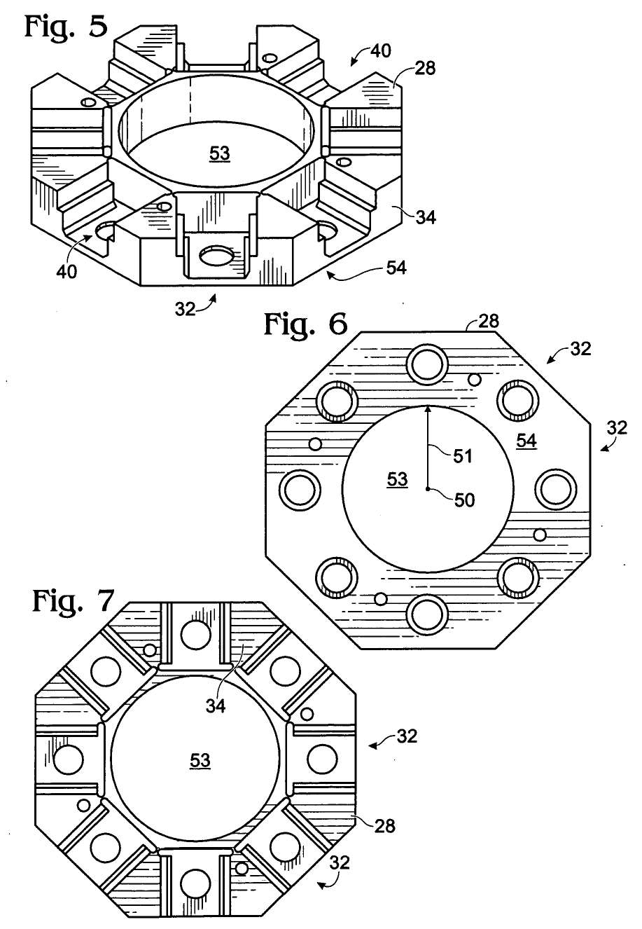

A crystal holder 28 may have a substantially circular central passage 53 with a size described by radius 51. In some embodiments, passage 53 of the holder may be configured so that the crystal holder 28 sits around the collar 60 the base plate 30. Similarly, the crystal holder's lower surface 54 may be shaped to have a close fit with an upper surface 68 of the base plate. Although difficult to see in FIGS. 5-7, in the illustrated embodiment the lower surface 54 of the crystal holder may be angled to match the angle of the upper surface 68 of the base plate 30. Angling the lower surface 54 of the crystal holder 28 may also aim crystal sites 32 toward any emitters 17 at the bottom of the vacuum chamber, allowing better exposure of crystals held at those sites to materials released by the emitters (as described in more detail below and as shown in FIGS. 1 and 4). Although the radius 51 and holder surface 54 may be configured for a close fit between the crystal holder and base plate, in the illustrated embodiment the crystal holder is rotatable on the upper surface of the base plate.

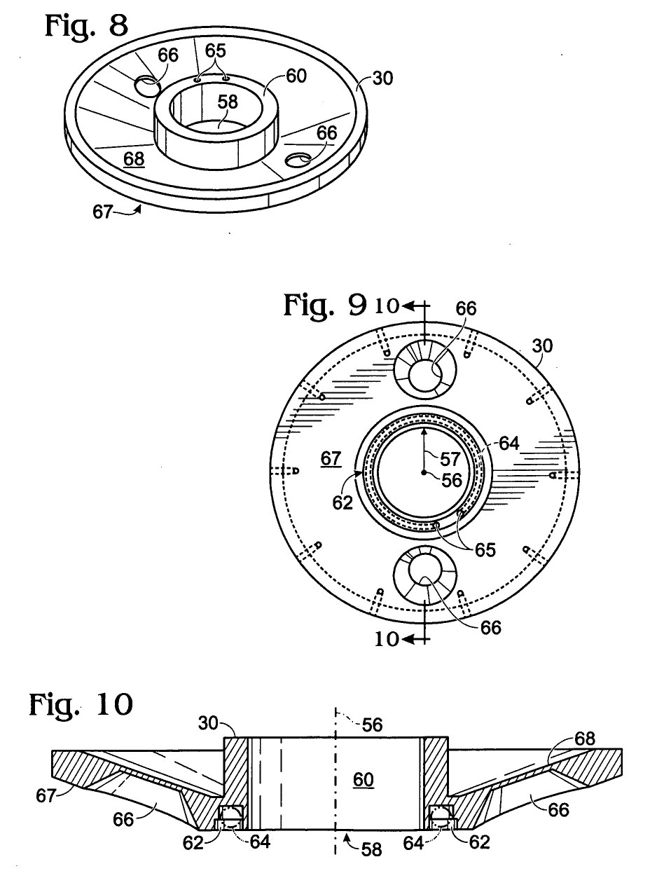

FIGS. 8-10 show an exemplary embodiment of a base plate 30 according to aspects of the present disclosure. In the illustrated embodiment, base plate 30 is substantially circular, arranged around a base plate axis 56. The base plate may include a generally circular, central base plate passage 58 having a radius 57. The passage may be surrounded by a base plate collar 60. A lower portion of the collar may include a cooling channel 62, configured to support one or more cooling pipes 64. Although shown as a circular passage 58 with a radius 57, it should be appreciated that other geometric constructions of the passage are within the scope of the present teachings.

When provided, cooling pipes such as pipes 64 may originate outside the vacuum chamber, cross the chamber pass-through 16, and loop in the base plate 30, as shown in FIGS. 9 and 10, entering and exiting the surface of the base plate through cooling pipe access holes 65. Although shown as making a simple loop around the base plate passage 58, the cooling channel 62 and its associated cooling pipe 64 may follow a more circuitous route along a surface of or through the base plate, as desired by operational considerations.

The base plate depicted in FIGS. 8-10 further includes crystal exposure openings 66. The crystal exposure openings may allow access of an atmospheric element, such as a material 13 emitted by an emitter 17, to reach at least a portion of a crystal holder resting above the base plate. In some embodiments, a single exposure opening in a base plate may allow exposure of only a single crystal to the vacuum chamber and material emitted by the emitters. In other embodiments, such as the one depicted in FIGS. 8-10, there may be two exposure openings 66 in the base plate. This latter design allows more than one crystal to be exposed to the emitted material and thus allows more than one crystal to receive an optical coating at the same time. This design has the benefit that crystal averaging (i.e. averaging the resonance frequency signals from more than one crystal) can be used, potentially resulting in more accurate measurement of the extent of material deposition. More than two exposure openings may be used, depending on desired performance parameters (e.g. greater crystal averaging).

As depicted, for example, in FIG. 10, the base plate may be constructed with angled lower 67 and upper 68 surfaces. In a case where plural emitters are located about a vacuum chamber, angling at least the lower surface 67 of the base plate allows the crystal exposure openings 66 to be aimed at or at least approximately toward emitters 17. Aiming the openings toward the emitters lessens the likelihood that a crystal supported in the crystal holder, and exposed in the opening, will be shielded from the emitter by the base plate, resulting in an inaccurate measurement of material production from the emitters.

As one example, in some vacuum chambers the emitters 17 are oriented such that they are directed at an angle α of about 20 degrees from the vertical rather than being directed vertically (see FIG. 1). In this case, a planar lower surface 67 of the base plate would shield a crystal in a holder above, unless crystal exposure openings 66 were quite large. Thus, it may be desirable to angle both the lower surface 54 of the crystal holder and the lower surface 67 of the base plate at a similar angle β of about 20 degrees from the vertical, matching the orientation of the emitters and allowing a straight path from an emitter to a crystal above (again shown in FIG. 1).

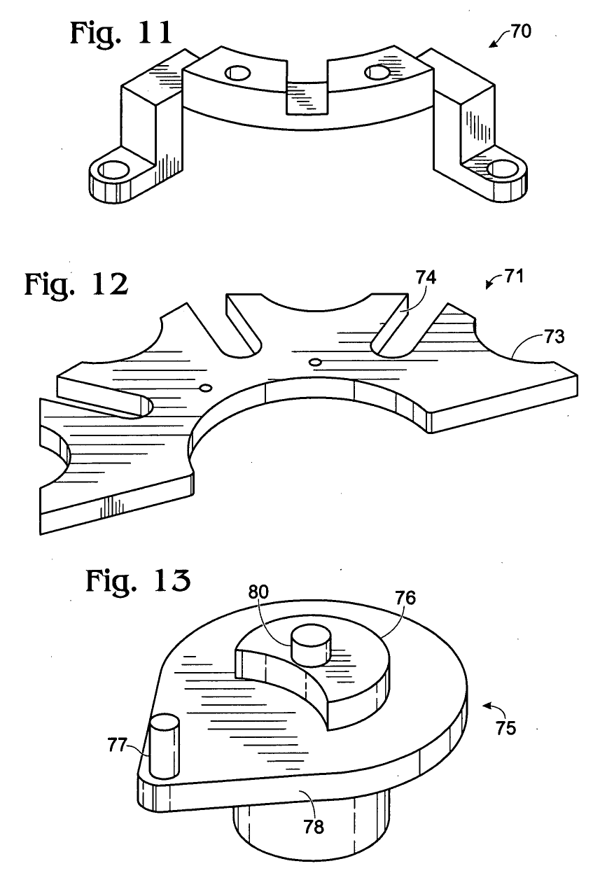

FIGS. 11-13 show elements of Geneva gear assembly 20. The Geneva gear assembly moves and indexes the crystal holder 28 so that a monitoring crystal 42 supported in the holder is accurately position above an exposure opening 66 in the base plate 30 during the process of monitoring and controlling material emitters in the vacuum chamber.

FIG. 11 shows a Geneva gear support 70. The support may be removably coupled to the crystal holder 28 and a Geneva gear 71 (FIG. 12) by one or more bolts 72 (FIG. 4). The support may, alternatively, be permanently coupled to either or both of the holder 30 and the gear 71. The support 70 serves to raise the gear above the level of the crystal holder 28, allowing, for example, access of communication wires 48 to wire connections 46 (FIG. 4). It should be appreciated that many other designs of the gear support 70 and coupling methods between the support and the gear or holder are possible and within the scope of the present teachings.

FIG. 12 shows an exemplary Geneva gear 71 for use with the illustrated crystal holder assembly. The gear as depicted may be used to index the crystal holder 28 to defined positions around its central axis 50. In the illustrated embodiment, the gear 71 has four journaled surfaces 73 separated by three drive slots 74. The illustrated gear requires only four journaled surfaces because there are eight crystal sites on the crystal holder and two exposure openings on the base plate; each journaled position exposes two quartz crystals to atmosphere (one at each of the two exposure openings 66), meaning four indexed movements suffice to expose all eight crystals to material deposition events. More or fewer exposure openings and/or crystal sites would increase or decrease the number of journal positions needed to align all the crystals in a given holder with the exposure openings.

FIG. 13 shows an exemplary Geneva gear driver 75. The driver 75 is used to incrementally move the Geneva gear 71 and thus the crystal holder to which it is operatively coupled. The driver 75 may interact with the gear via a journaled surface 76 and a drive pin 77. The journaled surface 76 and pin 77 may be supported on a drive body 78 which may, in turn, be moved by a motor (not shown) coupled to an axle 80 on the driver. The driver may be fixedly mounted to a portion of the base plate or to another portion of the monitoring and controlling assembly, according to design preferences, so long as free rotation of the crystal holder relative to the base plate is maintained.

Coupling of the Geneva gear only to the crystal holder means that the base plate's position may be substantially static and that its exposure openings may always be in alignment with the emitters. In other words, rotation of the Geneva driver in the illustrated embodiment causes movement only of the Geneva gear and its associated crystal holder, while the base plate remains stationary. Because it is stationary, the base plate, which serves as a shield to protect the crystal holder (and its supported crystals) from the emitters, can be of either simple or highly complex design depending on the required performance parameters and protection needs.

Recalling FIG. 1, the monitoring and controlling assembly may include an optical component assembly 12. A first end 81 (the proximal end) of the assembly may be located outside the vacuum changer, while a second end 82 (the distal end) of the assembly may be located within the vacuum chamber. The second end 82 of the assembly may include an optical chamber 84 that may hold one or more optical components 86. Typically, the chamber will store a plurality of optical components in a stack. Any material appropriate for use in measuring one or more properties of light reflected from a surface may be suitable for forming optical components 86.

An optical component 86 in the optical chamber 84 may serve as a target for a light source 88, with light reflected from the component being received at a light detector 90. Light 92 may be projected from the light source 88, reflected from the optical component 86, and received at detector 90. As noted earlier, measuring one or more properties of the light reflected from, or transmitted through, the optical component can allow a user to determine an amount of material deposited on that component.

Optical chamber 84 may be constructed as a substantially cylindrical body having a chamber radius 94 as measured from an axis 96 oriented along the length of the assembly 12. As is apparent from a consideration of the figures, the optical chamber 84 may be configured with a radius 94 sufficiently small to allow the chamber to reside within base plate passage 58 (and, thus, holder passage 53). In some embodiments, axes 50, 56 and 96 may overlap, meaning the crystal holder 28, base plate 30 and optical chamber 84 are coaxial. In other embodiments, axes 50, 56 and 96 may not overlap (for example, if any of the elements are shaped irregularly, or if the optical chamber is substantially smaller than the base plate and/or crystal holder passages) and/or the optical chamber may be offset from one or more of axes 50 and 56.

An optical component 86 in optical chamber 84 may be exposed to an optical coating until its performance deteriorates to the point at which it no longer can be used as an optical monitor. At this time, an internal switching mechanism (such as a simple sweeper arm, not shown) may be used to remove a used optical component from the stack of optical components, leaving a fresh (unused) optical component for exposure to the light source. An exemplary optical component switcher of this type is the Intellevation Test Glass Changer manufactured by Intellevation Ltd. of Scotland, United Kingdom.

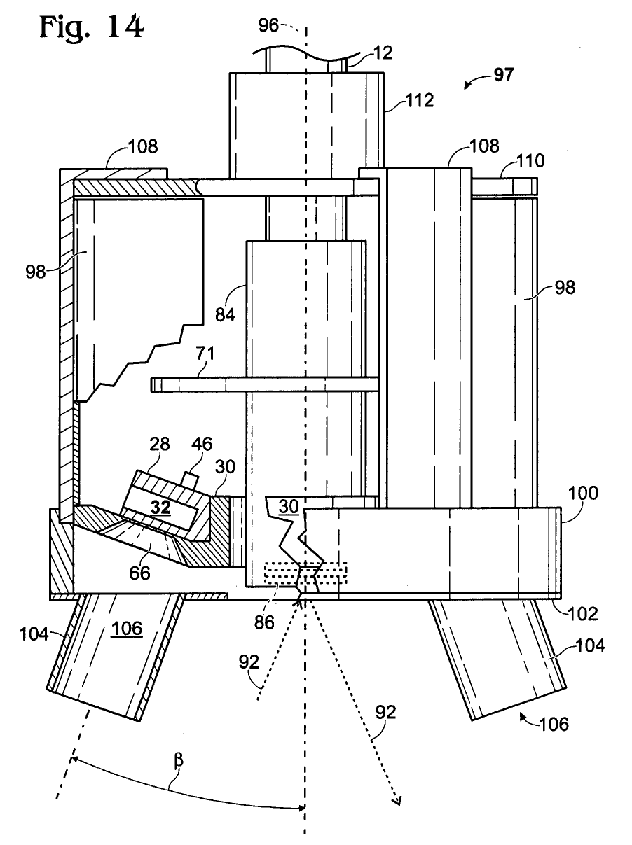

FIG. 14 shows one embodiment of a shielding system 97 that may be used with a monitoring and controlling system 10 according to the present disclosure. Shielding may be put into place near the monitoring and controlling system to prevent deposition onto the components of the system of vaporized elements (such as coating chemicals 13) emitted by the emitters 17. The bulk of the shielding system 97 may be made up of a semi-cylindrical shield 98, a static cylindrical shield 100, and a static plate shield 102.

Semi-cylindrical shield 98 may generally be discontinuously cylindrically shaped, meaning that the shield follows a roughly cylindrical path around the optical component assembly but that it does not form an enclosed cylinder. As well, the semi-cylindrical shield may not have a fixed position, but may rest on an upper portion of the base plate 30. In this way, the semi-cylindrical shield 98 may be substantially freely rotated around the glass changer axis 96 of the optical component assembly 12. That the semi-cylindrical shield 98 is not fully closed and is freely rotatable has the benefit that the open portion of the shield 98 may be rotated to provide access to any given crystal site 32 in a crystal holder 28. The semi-cylindrical shield 98 may, of course, be mounted in various other ways and still allow relatively free rotation of the shield and relatively free access to the crystal holder.

As noted, the shielding system 97 may include a static cylindrical shield 100 and static shield plate 102 that protect the bottom of the base plate and prevent emitted coating chemicals from being projected up onto the optical component assembly 12. Because one requirement for proper functioning of the monitoring/controlling assembly 10 is that it receive some amount of the emitted coating chemicals 13 from the emitters 17, the shield plate 102 may include one or more shield tubes 104 that each provide a shield tube passage 106 defining a pathway from an emitter (not shown) to a crystal exposure opening 66 associated with a particular shield tube. Each shield tube 104 is generally coupled to the shield plate 102 so that tube passage 106 is directed along angle β toward the emitters (as discussed above for the base plate), allowing coating chemicals to follow a relatively direct path from an emitter to a sensing crystal at a crystal site 32.

In some embodiments, the static cylindrical shield 100 and shield plate 102 may be coupled via one or more suspension brackets 108 to a support plate 110. For example, an upper portion of a suspension bracket 108 may be welded or bolted to support plate 110. A lower portion of the suspension bracket 108 may be welded or bolted to the static cylindrical shield 100. In this way, shield 100 may be held below the crystal holder 28 and the base plate 30 by the suspension bracket's attachment to support plate 110. Shield plate 102 may, in turn, be kept in place by being welded or bolted to static cylindrical shield 100. Alternatively, shield plate 102 may be welded or bolted directly to suspension bracket 108. Although in each case a shielding component may be described as being welded or bolted to another component, the interacting components may be coupled in any appropriate manner, such as via welding or bolting or through the use of adhesives, friction fittings, etc.

The support plate may be further coupled to a support cylinder 112, providing a stable structure from which the shield system 97 may be suspended. The support plate 110 and support cylinder 112 may be coupled to the optical component assembly 12 or to another portion of the monitoring/controlling assembly 10, or to a portion of the chamber 11. In any case, the assembly including the static cylindrical shield 100, shield plate 102, suspension brackets 108 and support plate 110 may form a “cage” within which the semi-cylindrical shield 98 may rotate.

Free rotation of the shield 98 within its “cage” may allow, as noted above, relatively free access to any given crystal site 32. This ease of access, in turn, may allow a user of the monitoring/controlling assembly 10 to relatively conveniently change out individual crystals from the crystal holder 28. The user may do so by rotating the open portion of the shield 98 to a location in front of a crystal site 32 in which a crystal to be replaced resides. The user may then withdraw the crystal drawer from the crystal site, replace the crystal in the drawer, and then reinsert the drawer to the site, all without major (or any) disassembly of the monitoring/controlling assembly.

The described system elements may be used in a method of monitoring and controlling material deposition. First, as noted in the background discussion, a quartz crystal (or other appropriate crystal) can be used to detect material deposition events, since material deposition on the crystal changes its mass and therefore its resonance frequency. According to the present disclosure, the crystal may be held at one of many crystal sites arranged about a central opening of a crystal holder, with the crystals being rotatably indexed by a Geneva gear mechanism. This mechanism allows a “new” crystal to be moved to a monitoring location above a material emitter when an “old” crystal accumulates so much deposited material that it can no longer accurately reflect deposition events.

Second, the described system may incorporate an optical component to detect material deposition events. Deposition of material on the optical component may change one or more characteristics of the light reflected by or transmitted through that component, and those characteristics can be monitored by a detector. Advantageously, as seen in the illustrated embodiment, the optical component is configured to reside within the central opening of the crystal holder. Constructing the system in this way allows both the quartz crystal and optical monitors to be supported by a single pass-through coupled to a wall of the vacuum chamber, and minimizes the area within the chamber obstructed or utilized by chamber monitoring systems.

In monitoring and controlling material deposition on a target object, a user may place into a vacuum chamber, via a single chamber pass-through, a combined crystal/optical monitor. The monitor may include a crystal holder assembly 14 having a crystal holder 28 and a base plate 30. The combined monitor may include, disposed coaxially or otherwise within a central passage 53 of the crystal holder, an optical chamber 84 of an optical component assembly 12. The user may arrange one or more target objects 18 on one or more planetary assemblies 19 in the vacuum chamber. Finally, the user may couple to one or more emitters 17 one or more materials 13 to be deposited on the target objects.

The user may also index the crystal holder 28 so that one or more of its crystal sites 32, with an associated crystal 42, is exposed to the emitters 17 through an exposure opening 66 of the base plate. The user may also ensure that a fresh (i.e. not previously exposed to a material deposition event) optical component 86 is arranged in the optical chamber 84 of the optical component assembly.

The user may begin the deposition process by causing the emitters 17 to vaporize materials 13 so that they enter the atmosphere of the vacuum chamber and become deposited on the target objects 18, any exposed crystal 42, and optical component 86. The user may monitor deposition of materials 13 onto the optical component 86 and a crystal 42 by monitoring a signal from a light detector 90 (giving the reflection from the optical component) and from the crystal 42 (giving the resonance frequency of the crystal). The user may control the rate of vaporization of the materials 13 by the emitters 17 in response to the change in resonance frequency of the crystal and the extent of material deposition by the change in reflectance from the optical component.

In one embodiment according to the present disclosure, the quartz crystal monitors may function to control a rate of material vaporization from the emitters in response to their being coated via material deposition. In the same embodiment, the optical monitors may be used in conjunction with the quartz crystal monitors, with the optical monitors being used to control an extent of material deposition (i.e. the endpoint of the process) in response to their being coated via material deposition. Alternatively, both the crystal and optical monitors may be used to control deposition rates, or both may be used to signal an endpoint to the deposition process. Furthermore, the roles of the different monitors may be reversed, with the crystal monitors used to signal an endpoint and the optical monitor used to control the deposition rate.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

I claim:

1. A system for monitoring and controlling a material deposition apparatus, comprising:
a crystal holder assembly configured to monitor a first material deposition event; and
an optical component assembly configured to monitor a second material deposition event, wherein the crystal holder assembly and the optical component assembly share an axis of rotational symmetry.

2. The monitoring and controlling system of claim 1, wherein the crystal holder assembly comprises at least a crystal holder and a base plate, wherein each of the crystal holder and the base plate have rotational symmetry and wherein the crystal holder and base plate are arranged coaxially.

3. The monitoring and controlling system of claim 2, wherein the crystal holder resides in a position above the base plate, and further wherein the base plate includes at least one exposure opening configured to allow exposure of an atmosphere to at least a portion of the crystal holder.

4. The monitoring and controlling system of claim 3, wherein the base plate includes two exposure openings configured to allow exposure of an atmosphere to the crystal holder.

5. The monitoring and controlling system of claim 1, wherein the crystal holder assembly includes a plurality of crystal sites, each configured to support at least one crystal.

6. The monitoring and controlling system of claim 5, further comprising at least one crystal drawer, wherein each crystal is reversibly held in a crystal drawer, and further wherein each crystal drawer is configured to be removably coupled to at least one crystal site.

7. The monitoring and controlling system of claim 5, wherein the crystal holder assembly has eight-fold rotational symmetry.

8. The monitoring and controlling system of claim 1, further including a Geneva mechanism coupled to the crystal holder assembly, wherein the Geneva mechanism is configured to move incrementally the crystal holder assembly around its axis.

9. A system for monitoring and controlling a material deposition apparatus, comprising:
a crystal holder assembly including:
a crystal holder having at least eight crystal sites symmetrically disposed about a central opening and configured to monitor a first material deposition event; and
a base plate disposed below the crystal holder, wherein the base plate has at least a pair of crystal exposure openings, each configured to expose a crystal site to a material deposition event; and
an optical component assembly disposed at least partially within the central opening of the crystal holder and configured to monitor a second material deposition event.

10. The monitoring and controlling system of claim 9, wherein the crystal holder assembly further includes at least one crystal drawer configured to hold a crystal and to be removably coupled to at least one crystal site.

11. The monitoring and controlling system of claim 10, wherein each crystal site has a corresponding crystal drawer to which it is removably coupled.

12. The monitoring and controlling system of claim 11, wherein the crystal holder is configured such that each crystal drawer can be removed without removing the crystal holder from the crystal holder assembly.

13. The monitoring and controlling system of claim 9, wherein the crystal holder resides adjacent to a surface of the base plate, wherein both the crystal holder and the base plate have rotational symmetry and further wherein the crystal holder and base plate are arranged coaxially.

14. A method of monitoring and controlling material deposition, comprising:
detecting a first plurality of material deposition events at a crystal, wherein the crystal is held at a crystal site in a crystal holder, and wherein the crystal holder includes a plurality of crystal sites arranged about a central opening; and
detecting a second plurality of material deposition events at an optical component resident within the central opening.

15. The monitoring and controlling method of claim 14, further comprising controlling a rate of material vaporization in response to detecting the first material deposition events.

16. The monitoring and controlling method of claim 14, further comprising controlling an extent of material deposition in response to detecting the second material deposition events.

17. The monitoring and controlling method of claim 14, further comprising:
controlling a rate of material vaporization in response to detecting the first material deposition events; and
controlling an extent of material deposition in response to detecting the second material deposition events.

18. The monitoring and controlling method of claim 17, wherein the crystal holder and the optical component holder are arranged about a shared axis of rotational symmetry.

19. The monitoring and controlling method of claim 18, wherein the crystal sites are arranged with eight-fold rotational symmetry.

20. The monitoring and controlling method of claim 19, wherein each crystal is reversibly held in a crystal drawer, and further wherein each crystal drawer is configured to be removably coupled to at least one crystal site.
